(19) United States
(12) Patent Application Publication
(10) Pub. No.: US 2025/0173445 A1
(43) Pub. Date: May 29, 2025

(54) METHOD AND APPARATUS FOR SECURITY ENHANCEMENT OF HARDWARE SECURITY MODULE USING ARTIFICIAL INTELLIGENCE

(71) Applicant: Marvell Asia Pte Ltd, Singapore (SG)

(72) Inventors: Deepanshu Tyagi, Hapur (IN); Dhanalakshmi Saravana, Koramangala (IN); Prateek Johri, Bareilly (IN)

(21) Appl. No.: 18/651,531

(22) Filed: Apr. 30, 2024

Related U.S. Application Data
(60) Provisional application No. 63/604,180, filed on Nov. 29, 2023.

(51) Int. Cl. G06F 21/57

(52) U.S. Cl. CPC G06F 21/577

(57) ABSTRACT

A new approach is proposed that contemplates system and method to support security enhancement for a hardware security module (HSM) using artificial intelligence (AI). Specifically, one or more AI models are trained with datasets of the HSM to establish a pattern of normal/typical behaviors for each of a plurality of applications requesting services of the HSM. While the HSM is running, an AI security module running on the HSM is configured to continuously monitor and analyze service requests from the plurality of applications to the HSM using the one or more trained AI models to identify security breaches/threats. If the AI models detect an anomaly or a deviation from its normal pattern of behaviors, the AI security module marks the application as a potential security threat and stops the HSM from performing a cryptographic operation requested by the application.

### RELATED APPLICATION

This application is a nonprovisional application and claims the benefit and priority to a provisional application No. 63/604,180 that was filed on Nov. 29, 2023, which is incorporated herein by reference in its entirety.

### BACKGROUND

A hardware security module (HSM) is a physical computing device that safeguards and manages secret and confidential information (e.g., digital keys and data) of a user which applications use the HSM. HSMs play a vital role in providing a security environment for various cryptographic operations such as encryption and decryption, digital signatures, strong authentication, as well as other cryptographic functions. HSMs are mainly used to generate, derive, store, and manage cryptographic keys, secure computation via encryption and decryption, and protect sensitive data of the user from unauthorized access and attacks.

HSMs typically have certain security protection measures in place to prevent tampering by cyberattacks. However, as the cyber security threat landscape continues to evolve, those security protection measures alone may not be sufficient to identify complex security threats and vulnerabilities of the HSMs. For example, HSMs may not have a fix yet against cyberattacks that happened very recently and may not be able to detect cyberattacks if a system administrator's credentials are compromised.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of a system to support HSM security enhancement via artificial intelligence according to one aspect of the present embodiments.

FIG. 2 depicts a flowchart of an example of a process to support HSM security enhancement via artificial intelligence according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

A new approach is proposed that contemplates system and method to support security enhancement for a hardware security module (HSM) using artificial intelligence (AI). Specifically, one or more AI models are trained with datasets of the HSM to establish a pattern of normal/typical behaviors for each of a plurality of applications (users of the HSM) requesting services of the HSM. While the HSM is running, an AI security module running on the HSM is configured to continuously monitor and analyze service requests from the plurality of applications to the HSM using the one or more trained AI models to identify security breaches/threats. If the AI models detect an anomaly or a deviation from its normal pattern of behaviors, the AI security module marks the application as a potential security threat and stops the HSM from performing a cryptographic operation requested by the application.

By constantly monitoring applications' service requests, the proposed approach provides real time visibility into security breaches and threats to the HSM. Since the HSM is used to protect and process sensitive data of the applications/users, running AI models on the HSM provides an additional layer of security for the users and makes it harder for cyber attackers to tamper with or compromise the HSM. In addition, the AI-powered HSM can assist in meeting compliance requirements for the HSM.

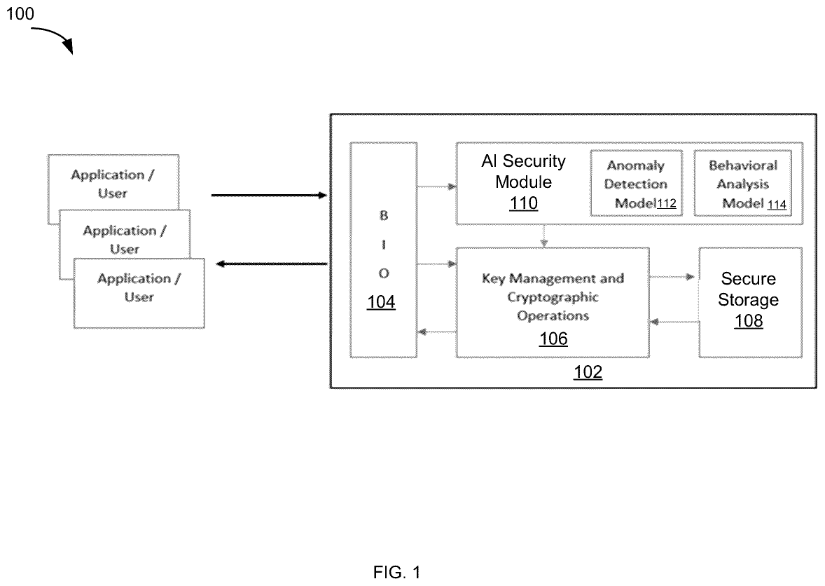

FIG. 1 depicts an example of a diagram of a system 100 to support HSM security enhancement via artificial intelligence. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a basic I/O (BIO) module 104, a key management and crypto operation module 106, a secure storage 108, and an AI security module 110. The system 100 and its components run on a hardware security module (HSM) 102, which is a multi-chip embedded hardware/firmware cryptographic module having software, firmware, hardware, or another component that is used to effectuate a purpose. In some embodiments, the HSM 102 is certified under Federal Information Processing Standard (FIPS) 140-2 Level 2 and 3 for performing secured key management cryptographic (crypto) operations. In some embodiments, the HSM 102 is preconfigured with default network and authentication credentials so that the HSM 102 can be FIPS/Common Criteria/PCI compliant for key management and crypto operations. In some embodiments, the FIPS certified HSM 102 includes one or more processors and storage units (not shown). In some embodiments, the one or more processors include a multi-core processor and a security processor, wherein the security processor is configured to perform crypto operations with hardware accelerators with embedded software implementing security algorithms.

In the example of FIG. 1, the BIO module 104 is configured to accept a plurality of service requests from a plurality of applications/users to the HSM 102, wherein each of the plurality of applications can be but is not limited to a cloud-based user application, e.g., one hosted by a web service such as Amazon Web Service (AWS). Here, the BIO module 104 communicates with the plurality of applications over a network (not shown) following certain communication protocols such as TCP/IP protocol. Such network can be but is not limited to, internet, intranet, wide area network (WAN), local area network (LAN), wireless network, Bluetooth, WiFi, mobile communication network, or any other network type.

In some embodiments, the BIO module 104 is configured to parse each of the plurality of service requests accepted to identify a type of service requested by a specific application. Here, the types of services requested include but are not limited to key generation, key export, key deletion, secured key and data storage, and crypto (e.g., encryption and decryption) operations of the keys and data. The BIO module 104 then invokes the corresponding handler/component of the key management and crypto operation module 106 to process the specific type of service requested by the application together with the data embedded in or pointed to by the service request. Once the service request has been processed by the key management and crypto operation module 106, the BIO module 104 may compose a response including a processing result and transmit the response back to the application sending the service request.

In the example of FIG. 1, the key management and crypto operation module 106 is configured to perform a key management or crypto operation/service according to the type of service requested by each of the plurality of applications. For non-limiting examples, the key management or crypto operation can be but is not limited to, generating a new key, storing the key into the secure storage 108, exporting the key back to the application, deleting an existing key from the secure storage 108, encrypting or decrypting data using the key, and storing the encrypted or decrypted data in the secure storage 108. The key management and crypto operation module 106 then provides the processing result (e.g., the generated key) back to the requesting application through the BIO module 104. In some embodiments, the key management and crypto operation module 106 is configured to stop or abort the key management or crypto operation if an alert of potential security compromise is raised for the specific operation and/or the application requesting the service. In this case, the key management and crypto operation module 106 will inform the requesting application that its service request has been declined through the BIO module 104.

In the example of FIG. 1, the secure storage 108 is configured to maintain various types of information/data associated with the plurality of applications in a secure environment. Such information includes but is not limited to keys, encrypted data, decrypted data and any other confidential or proprietary information of each of the plurality of applications. In some embodiments, the secure storage 108 includes multiple types of storage devices, including but not limited to, dynamic random access memory (DRAM) and flash for key and data storage, ferroelectric RAM (FRAM) for storing critical logs, and eFuse for one time key write that cannot be erased, etc.

In some embodiments, the BIO module 104 is configured to also send each of the plurality of service requests to the AI security module 110 for security risk analysis. In the example of the FIG. 1, the AI security module 110 is configured to continuously monitor and analyze each of the plurality of service requests received by the HSM 102 to identify security risk associated with the service request from a specific application via one or more AI models. Here, each of the one or more AI models is a software component that applies one or more algorithms to data to recognize patterns, make predictions or make decisions. In some embodiments, the one or more AI models include an anomaly detection model 112, which uses one or more statistical methods or machine learning algorithms to detect the anomalies in the data. This model does not rely on predefined rules or patterns and can detect previously unseen threats, such as zero-day attacks. In some embodiments, the one or more AI models include a behavior analysis model 114, which establishes a baseline/pattern of normal behavior and then analyzing deviations from the pattern by the service request to detect the suspicious activities. This model relies on predefined rules, which make it more suitable for known or internal threats or patterns of misuse. By incorporating both the anomaly detection model and the behavior analysis model, the AI security module 110 significantly enhances the overall security of the HSM 102.

In some embodiments, the one or more AI models are trained ahead of time with one or more large datasets of the plurality of service requests to the HSM 102 from each of the application using services before the one or more AI models are deployed/loaded into the AI security module 110. Here, training of the one or more AI models is a process of teaching the AI models to perform one or more tasks by exposing the AI models to the large datasets. In some embodiments, the datasets used to train the one or more AI models include but are not limited to volumes of logs of requests from the plurality of applications, transactions performed for the applications, and other historical security-related data of the HSM 102. In some embodiments, the AI security module 110 is configured to continuously train the one or more AI models with data (e.g., service requests of the applications) received after the one or more AI models have been deployed in order to keep the one or more AI models accurate and update to date following deployment.

During the training, the one or more models analyze the datasets to learn anomalies and to identify/establish a pattern of behavior associated with each of the plurality of applications for their usage of one or more functions and services in the HSM 102 during a lifecycle of crypto operations. For example, the pattern of behavior associated with an application may include one or more of distribution of a plurality of service requests sent by the application over a certain period of time (e.g., e.g., day, month, year, or since beginning of use), the types and/or frequencies of the services requested by the service requests (e.g., how often is key is requested to be exported or deleted), how many of the service requests were rejected in the past, etc. The pattern of behavior establishes an underlying baseline/threshold of “normal” behavior for each application using the HSM 102, wherein such pattern of behaviors can be utilized by the AI security module 110 to make predictions about potential security threats via anomaly detection and behavioral analysis of the application.

Utilizing the one or more AI models, the AI security module 110 is configured to identify one or more anomalies, e.g., security risks and vulnerabilities associated with the service request from the application or if the service request deviates beyond a certain threshold from the pattern of behavior of the application. In some embodiments, the threshold can be specified or defined by the user. For example, the AI security module 110 may deem a service request from an application for generating or exporting a master key as suspicious if the application just requested for the same key a moment before or has requested for the same key numerous times over a short time period, indicating that the application might have been compromised or hijacked by an attacker. For another example, the AI security module 110 may deem an application as suspicious if it has requested encryption or decryption of data numerous times during a short period of time.

If an anomaly or a deviation is detected for a service request by an application, the AI security module 110 may send an alert to the key management and crypto operation module 106 to stop performing the key management or crypto operation requested by the application. In some embodiments, the alert may trigger a tamper protection mechanism of the key management and crypto operation module 106 to protect existing user keys and data from being accessed or tampered by the application. In some embodiments, the key management and crypto operation module 106 is configured to block any future service request from the application if the alert is received. In some embodiments, the key management and crypto operation module 106 is configured to notify an administrator, user, owner or host of the application through the BIO module 104 that the application may have been compromised by an attacker to launch a cyberattack.

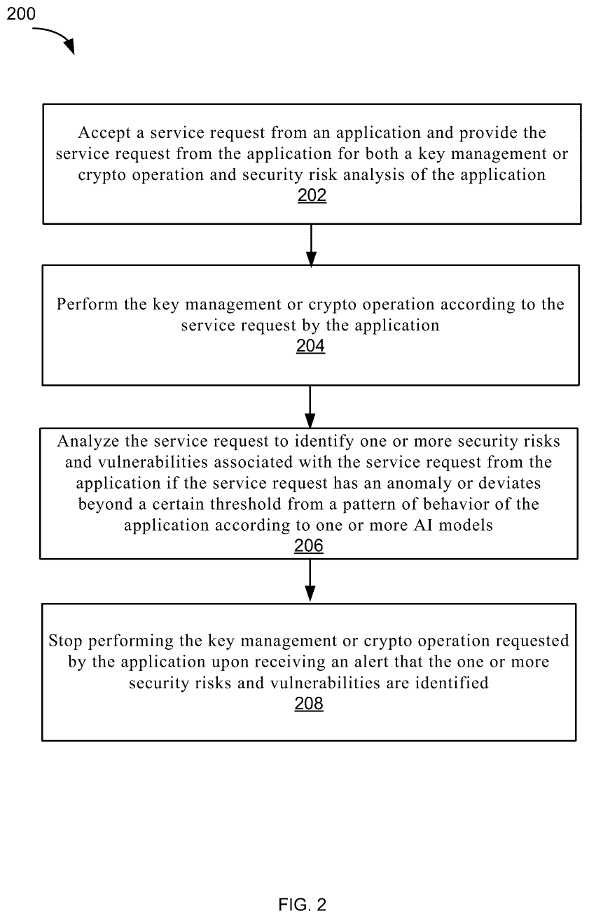

FIG. 2 depicts a flowchart 200 of an example of a process to support HSM security enhancement via artificial intelligence. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 2, the flowchart 200 starts at block 202, where a service request from an application is accepted and provided for both a key management or crypto operation and security risk analysis of the application. The flowchart 200 continues to step 204, where the key management or crypto operation is performed according to the service request by the application. The flowchart 200 continues to step 206, where the service request is analyzed identify one or more security risks and vulnerabilities associated with the service request from the application if the service request has an anomaly or deviates beyond a certain threshold from a pattern of behavior of the application according to one or more AI models. The flowchart 200 ends at step 208, where performing the key management or crypto operation requested by the application is stopped upon receiving an alert that the one or more security risks and vulnerabilities are identified.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system running on a hardware security module (HSM), comprising:
an I/O module configured to accept a service request from an application to the HSM and provide the service request from the application to a key management and crypto operation module for a key management or crypto operation and an artificial intelligence (AI) security module for security analysis of the application;
said key management and crypto operation module configured to perform the key management or crypto operation according to the service request by the application; and
said AI security module configured to
analyze the service request received by the HSM to identify one or more security risks and vulnerabilities associated with the service request from the application if the service request has an anomaly or deviates beyond a certain threshold from a pattern of behavior of the application according to one or more AI models; and
send an alert to the key management and crypto operation module to stop performing the key management or crypto operation requested by the application if the one or more security risks and vulnerabilities are identified.

2. The system of claim 1, wherein:
the I/O module is configured to identify a type of service requested by the application to be performed by the HSM.

3. The system of claim 1, wherein:
the I/O module is configured to compose and transmit a response including a processing result back to the application sending the service request once the service request has been processed.

4. The system of claim 1, wherein:
the I/O module is configured to inform the application that the service request has been declined if the alert is received for the service request of the application.

5. The system of claim 1, wherein:
the key management or crypto operation is one of generating a key, storing the key into a secure storage, exporting the key back to the application, deleting an existing key from the secure storage, encrypting or decrypting data using the key, and storing the encrypted or decrypted data in the secure storage.

6. The system of claim 1, wherein:
the key management and crypto operation module is configured to stop or abort the key management or crypto operation if the alert is received.

7. The system of claim 1, wherein:
the key management and crypto operation module is configured to block any future service request from the application if the alert is received.

8. The system of claim 1, wherein:
the key management and crypto operation module is configured to notify an administrator, user, owner or host of the application that the application has been compromised.

9. The system of claim 1, wherein:
the one or more AI models are trained ahead of time with one or more datasets of a plurality of service requests to the HSM from the application before the one or more AI models are deployed into the AI security module.

10. The system of claim 9, wherein:
the AI security module is configured to continuously train the one or more AI models with data of the application received after the one or more AI models have been deployed.

11. The system of claim 1, wherein:
the one or more AI models include an anomaly detection model, which uses one or more statistical methods or machine learning algorithms to detect the anomaly in the service request without relying on predefined rules or patterns.

12. The system of claim 1, wherein:
the one or more AI models include a behavior analysis model, which establishes the pattern of behavior of associated with the application for its usage of one or more functions and services in the HSM during a lifecycle of crypto operations.

13. The system of claim 12, wherein:
the pattern of behavior associated with the application includes one or more of distribution of a plurality of service requests sent by the application over a certain period of time, types and/or frequencies of services requested by the service requests, and how many of the service requests were rejected before.

14. A system, comprising:
a hardware security module (HSM) configured to
accept a service request from an application and provide the service request from the application for both a key management or crypto operation and security risk analysis of the application;
perform the key management or crypto operation according to the service request by the application;
analyze the service request to identify one or more security risks and vulnerabilities associated with the service request from the application if the service request has an anomaly or deviates beyond a certain threshold from a pattern of behavior of the application according to one or more AI models; and
stop performing the key management or crypto operation requested by the application upon receiving an alert that the one or more security risks and vulnerabilities are identified.

15. The system of claim 14, wherein:
the HSM is a multi-chip embedded hardware/firmware cryptographic module.

16. The system of claim 14, wherein:
the HSM includes a secure storage configured to maintain keys and data associated with the application in a secure environment.

17. A method for security enhancement of hardware security module (HSM), comprising:
accepting a service request from an application and providing the service request from the application for both a key management or crypto operation and security risk analysis of the application;
performing the key management or crypto operation according to the service request by the application;
analyzing the service request to identify one or more security risks and vulnerabilities associated with the service request from the application if the service request has an anomaly or deviates beyond a certain threshold from a pattern of behavior of the application according to one or more AI models; and
stopping performing the key management or crypto operation requested by the application upon receiving an alert that the one or more security risks and vulnerabilities are identified.

18. The method of claim 17, further comprising:
identifying a type of service requested by the application to be performed by the HSM.

19. The method of claim 17, further comprising:
composing and transmitting a response including a processing result back to the application sending the service request once the service request has been processed.

20. The method of claim 17, further comprising:
informing the application that the service request has been declined if the alert is received for the service request of the application.

21. The method of claim 17, further comprising:
blocking any future service request from the application if the alert is received.

22. The method of claim 17, further comprising:
notifying an administrator, user, owner or host of the application that the application has been compromised.

23. The method of claim 17, further comprising:
training the one or more AI models ahead of time with one or more datasets of a plurality of service requests to the HSM from the application before the one or more AI models are deployed to the HSM.

24. The method of claim 23, further comprising:
continuously training the one or more AI models with data of the application received after the one or more AI models have been deployed to the HSM.

25. The method of claim 17, further comprising:
utilizing one or more statistical methods or machine learning algorithms to detect the anomaly in the service request without relying on predefined rules or patterns.

26. The method of claim 17, further comprising:
establishes the pattern of behavior associated with the application for its usage of one or more functions and services in the HSM during a lifecycle of crypto operations.

27. A system, comprising:
a means for accepting a service request from an application and providing the service request from the application for both a key management or crypto operation and security risk analysis of the application;
a means for performing the key management or crypto operation according to the service request by the application;
a means for analyzing the service request to identify one or more security risks and vulnerabilities associated with the service request from the application if the service request has an anomaly or deviates beyond a certain threshold from a pattern of behavior of the application according to one or more AI models; and
a means for stopping performing the key management or crypto operation requested by the application upon receiving an alert that the one or more security risks and vulnerabilities are identified.
